(19) United States
(12) Patent Application Publication
(10) Pub. No.: US 2006/0285087 A1
(43) Pub. Date: Dec. 21, 2006

(54) Dual lamp system for projector system with L-type optical engine

(75) Inventor: Junejei Huang, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/471,303

(22) Filed: Jun. 19, 2006

(30) Foreign Application Priority Data
Jun. 20, 2005 (TW) 94120507

(51) Int. Cl. G03B 21/26

(52) U.S. Cl. 353/94

(57) ABSTRACT

Disclosed is a light source module, particularly used in a projector system, comprising a first and a second light sources generating a first and second light rays, a first and a second reflective mirrors disposed on a respective light path of the first and second light rays to control a respective direction of the first and second light rays, respectively, and a light integrating device having a first prism, a second prism and a light integrating rod and disposed behind the first and second reflective mirrors on the respective light paths of the first and second light rays, wherein the first and second light rays are received by the first and second prisms respectively and collected to the light integrating rod.

### FIELD OF THE INVENTION

The present invention relates to a light source module for a projector system. More particularly, the present invention relates to a light source module for a projector system with an L-type optical engine.

### BACKGROUND OF THE INVENTION

In recent years, the projector system has been widely utilized in many applications, such as the briefing and multi-media system for conference use, the image projection system for theater use and the front or back project system for home use. Generally, a projector system typically comprises a light source module, Color separation/combination components, an optical valve module and a lens assembly. Among them, the light source module can be the most critical assembly in terms of the overall luminance and color uniformity of the projector system. For the light source module used in the current projector system, it is typically composed of a light source and a plurality of optical lens assemblies. The optical lens assemblies are used not only for adjustment of the direction of the light emitted from the light source but also for homogenization of the light.

The projector system has an optical engine therein, which may be categorized into S-type optical engine and L-type optical engine in terms of light guiding direction, shown in FIG. 1A and FIG. 1B, respectively. Since the L-type optical engine has a simple structure, it is more widely used in the projector system. Generally, no matter which type of the optical engine is used, the impinging direction of the light source is designed as perpendicular with respect to the projection direction of the projector system with a single light source so that the projector system is allowed to have a uniform light ray projected when it is inclined. However, there is an increased demand placed on the luminance and color uniformity performance of the display products and thus the light source module has to be more delicately designed. To this end, the multi-light source scheme has been introduced into the projector system. However, this may involve a more complicated design with respect to the light source module. In designing such light source module, there are some issues required to be concerned. First, how can the light rays from the different light sources be properly coupled in a manner that the use efficiency of the light source is enhanced, the light rays be prevented from being interfered with each other, and the aberration be obviated, should be addressed. Next, the impinging direction of the light rays from the different sources is required to be maintained perpendicular to the projection direction of the projector system.

To address these problems, the applicant of the present invention filed a Taiwanese patent application, entitled “MULTI-LIGHT SOURCE STRUCTURE AND LIGHT INTEGRATING DEVICE FOR PROJECTOR SYSTEM” with application Ser. No. 92/128,258, Oct. 13, 2003. In this patent, an integrating device is disclosed to effectively receive the light rays from the multiple light sources so that the light rays may be collected and homogenized and then outputted, which is shown in FIG. 2A. Specifically, the light source module 10 comprises a first light source assembly 11, a second light source assembly 12 and a light integrating device 13. The first light source assembly 11 includes a bulb 111 and a reflective lamp mask 112, while the second light source assembly includes a bulb 121 and a reflective lamp mask 122. The bulb 111 emits a light ray a, which is then reflected by the corresponding reflective lamp mask 112 and projected to the light integrating device 13. The bulb 121 emits a light ray b, which is then reflected by the corresponding reflective lamp mask 122 and projected to the light integrating device 13. To understand the detail of the light integrating device 13, refer further to FIG. 2B. The light integrating device 13 comprises a first prism 131 and a second prism 132 and a light integrating rod 133. The first prism 131 includes an incident surface 1311 and a reflective surface 1312 standing at forty-five degrees with respect thereto so that the light ray a is guided towards the light integrating rod 133. The second prism 132 includes an incident surface 1321 and a reflective surface 1322 standing at forty-five degrees with respect thereto so that the light ray b is guided towards the light integrating rod 133.

Although this light source module with the dual-lamp structure may be enhanced in the light source efficiency, the allowed inclination angle of the projector system is limited since the impinging directions of the two light sources are in parallel to the projection direction of the projector system when being used in the projector system with the L-type optical engine. In addition, the two bulbs are each required to be disposed at an angle smaller than twenty degrees as possible as they can when the bulb lifetime and heat dissipation issues are concerned. In this regard, the light source module still leaves something to be improved.

Therefore, the inventor of the present invention sets forth a dual lamp system for an L-type optical engine based on the Taiwanese patent “MULTI-LIGHT SOURCE STRUCTURE AND LIGHT INTEGRATING DEVICE FOR PROJECTOR SYSTEM” and with the consideration of the bulb lifetime and heat management issues, so as to increase the applicable range of the light source module.

### SUMMARY OF THE INVENTION

In accordance with an aspect of the present invention, a light source module is disclosed, which comprises a first and a second light sources generating a first and second light rays, a first and a second reflective mirrors disposed on a respective light path of the first and second light rays to control a respective direction of the first and second light rays, respectively, and a light integrating device having a first prism, a second prism and a light integrating rod and disposed behind the first and second reflective mirrors on the respective light paths of the first and second light rays, wherein the first and second light rays are received by the first and second prisms respectively and collected to the light integrating rod.

In a preferred embodiment, the first prism has a first exit surface, the second prism has a second exit surface and the light integrating rod has an incident surface connected with the first and second exit surfaces of the first and second prisms to collect and homogenize the first and second light rays.

In a preferred embodiment, the light integrating device further comprises a metal bracket for fixing the first and second prisms and the light integrating rod.

In a preferred embodiment, the metal bracket has a plurality of slots so that the first and second prisms and the light integrating rod are maintained in contact with the metal bracket at a plurality of points on a cross sectional surface of the meta bracket, respectively.

In a preferred embodiment, the metal bracket further comprises a base, a first side frame, a second side frame, a press cover and a stop plate.

In a preferred embodiment, each of the first and second prisms has at least a long side fixed between the base and the first side frame.

In a preferred embodiment, the light integrating rod has at least a long side fixed between the base and the second side frame.

In a preferred embodiment, each of the first and second prisms and the light integrating rod has a front side surface and a rear side surface respectively fixed by the press cover and the stop plate.

In a preferred embodiment, the light source further comprises a first UV-filter and a second UV-filter disposed between the first and second light sources and between the first and second reflective mirrors, respectively.

In a preferred embodiment, each of the first and second prisms has an incident surface and a reflective surface standing at an angle θ with respect thereto.

In a preferred embodiment, the angle θ satisfies the following equation: θ=½[90°+sin⁻¹(sin(α)/n)], wherein α is an incident angle of one of the first and second light rays with respect to one of the first and second prisms, and n is an index of refraction of one of the first and second prisms.

In a preferred embodiment, the light source module is used for a projector system.

In accordance with another aspect of the present invention, a light integrating device for a projector system is disclosed, which comprises a first prism having a first exit surface and a long axis, a second prism having a second exit surface, and disposed in parallel with the long axis of the first prism, a light integrating rod having a third incident surface connected to the first and second light exit surfaces, and a metal bracket bearing thereon and calibrating the first and second prisms and the light integrating rod.

In a preferred embodiment, the metal bracket further comprises a base, a first side frame, a second side frame, a press cover and a stop plate.

In a preferred embodiment, each of the first and second prisms has at least a long side fixed between the base and the first side frame.

In a preferred embodiment, the light integrating rod has at least a long side fixed between the base and the second side frame.

In a preferred embodiment, each of the first and second prisms and the light integrating rod has a front side surface and a rear side surface fixed by the press cover and the stop plate.

In a preferred embodiment, the metal bracket has a plurality of slots so that the first and second prisms and the light integrating rod are maintained in contact with the metal bracket at a plurality of points on a cross sectional surface of the metal bracket, respectively.

In a preferred embodiment, the light integrating device is used for a projector system.

In accordance with yet another aspect of the present invention, a light source module is disclosed, which comprises a lamp tank having at least a pair of light sources and at least a pair of reflective mirrors for generating a first light ray and a second light ray, a light integrating device having a pair of prisms and a light integrating rod for transmitting and homogenizing the first and second light rays, and a metal bracket bearing thereon and calibrating the pair of prisms and the light integrating rod so as to reduce a loss of the first and second light rays transmitted and homogenized by the pair of prisms and the light integrating rod, wherein each of the pair of prisms has a respective light exit surface and the light integrating rod has an incident surface connected therewith so that the first and second light rays are transmitted to the light integrating rod and collected, homogenized by the light integrating rod.

In a preferred embodiment, the incident surface of the light integrating rod is connected totally with the respective light exit surface of each of the pair of prisms.

In a preferred embodiment, each of the first and second light rays is incident into the pair of prism after one time of reflection.

In a preferred embodiment, the pair of reflective mirrors are respectively used to adjust positions of the first and second light rays incident onto the pair of prisms.

In a preferred embodiment, the light source further comprises a pair of UV-filters between the pair of light sources and the pair of reflective mirrors.

In a preferred embodiment, the metal bracket has a plurality of slots so that the pair of prisms and the light integrating rod are maintained in contact with the metal bracket at a plurality of points on a cross sectional surface of the metal bracket, respectively.

In a preferred embodiment, the light source module as claimed in claim 21, wherein the metal bracket further comprises a base, a first side frame, a second side frame, a press cover and a stop plate.

In a preferred embodiment, each of the first and second prisms has at least a long side fixed between the base and the first side frame.

In a preferred embodiment, the light integrating rod has at least a long side fixed between the base and the second side frame.

In a preferred embodiment, each of the pair of prisms and the light integrating rod has a front side surface and a rear side surface respectively fixed by the press cover and the stop plate.

With use of the present invention, the light integrating device can be provided in cooperation with the light source arrangement and fixed in the light source module simply and rapidly without the need of additional complex elements.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods and disclosed or illustrated. In the drawings:

FIG. 1A is a schematic diagram of an S-type optical engine for a projector system;

FIG. 1B is a schematic diagram of an L-type optical engine for the projector system;

FIG. 2A is a schematic diagram of a conventional light source module of the projector system;

FIG. 2B is a schematic diagram of a light integrating device of the conventional light source module shown in FIG. 2A;

FIG. 3 is a schematic diagram of a light source module according to an embodiment of the present invention;

FIG. 4 is a schematic diagram of a first prism of the light source module shown in FIG. 3;

FIG. 5A is a schematic diagram of a possible arrangement of the light integrating device according to the present invention;

FIG. 5B is a schematic diagram of another possible arrangement of the light integrating device according to the present invention;

FIG. 6A is an exploded diagram of the light integrating module according to the present invention;

FIG. 6B is a side view of a portion of the light integrating device; and

FIG. 6C is a cross-sectional view of the light integrating module shown in FIG. 6A.

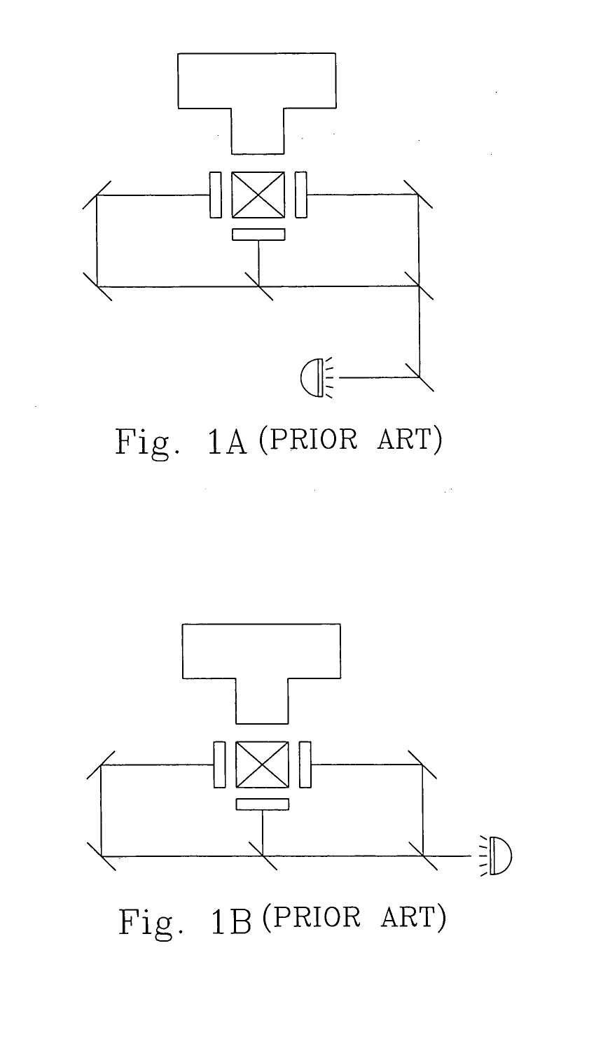

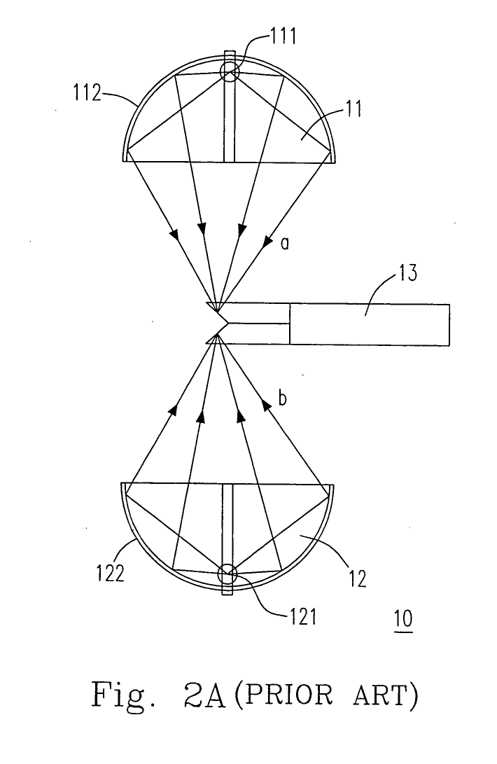

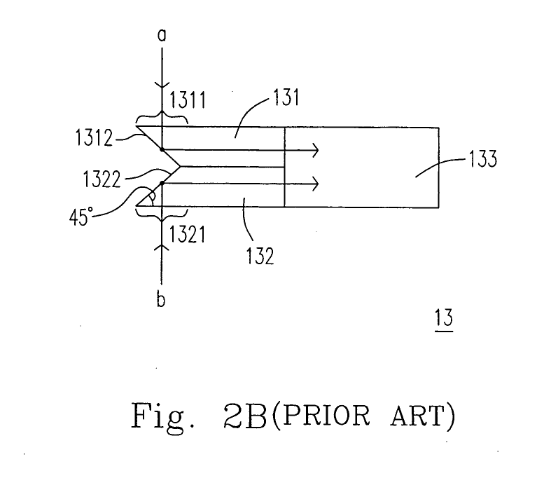

### DETAILED DESCRIPTION OF THE PREFERRED EMBODIMENT

The present invention discloses a light source module for a projector system with an L-type optical engine, which will be described in detail below taken with the preferred embodiments with reference to the accompanying drawings.

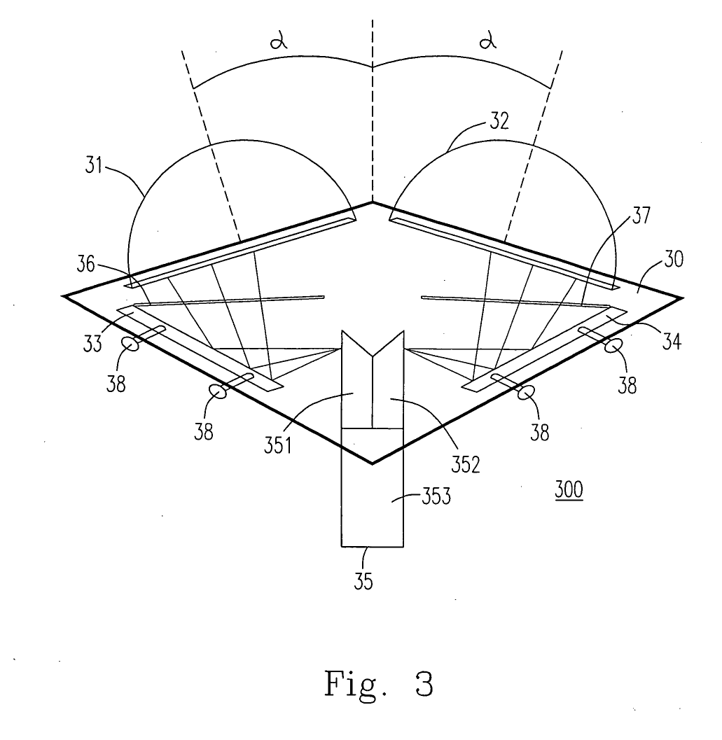

Referring to FIG. 3, a schematic diagram of a light source module according to an embodiment of the present invention is depicted therein. As shown, the light source module 300 comprises a first light source 31, a second light source 32, a first reflective mirror 33, a second reflective mirror 34 and a light integrating device 35. The components 31-35 are fixed within a lamp tank 30. Of them, each of the first and second reflective mirrors 33, 34 is disposed opposite to a respective opening (not shown) of the first and second light sources 31, 32, and stands at an inclination angle, respectively. As such, a first and second light rays a, b may be incident to the light integrating device 35 after one time of reflection on the first and second reflective mirrors 33, 34, respectively. Outside the openings of the first and second light sources 31, 32, respective UV-filters 36, 37 may be further disposed so that respective ultraviolet components of the first and second light rays a, b may be filtered out before the first and second light rays a, b reach the first and second reflective mirrors 33, 34, respectively.

As shown, the first and second reflective mirrors 33, 34 are fixed onto the lamp tank 30 through a plurality of screws 38. In addition to the fixation with respect to the first and second reflective mirrors 33, 34, the plurality of screws 38 are also used to adjust respective inclination angles of the first and second reflective mirrors 33, 34 so that each of the first and second light rays a, b may be incident to the light integrating device 35 at a proper angle.

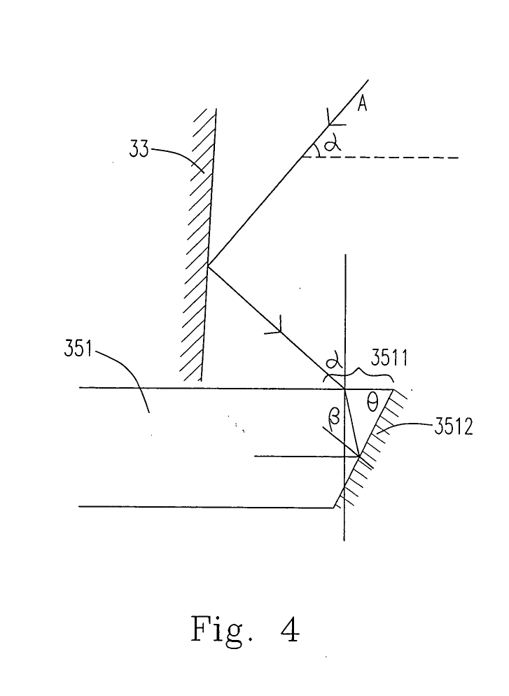

Like that in the prior art, the light integrating device 35 also has a first prism 351, a second prism 352 and a light integrating rod 353. However, each of the first and second prisms 351, 352 has a particular structure, which should be varied according to the arrangement of the first and second light sources 31, 32. Referring to FIG. 4, a schematic diagram of the first prism 351 shown in FIG. 3 is depicted therein. As shown, the first prism 351 has an incident surface 3511 and a reflective surface 3512 with respect to a first light ray a. The incident surface 3511 stands at an angle θ with respect to the reflective surface 3512. In this embodiment, since the first light ray a does not directly impinge on the incident surface 3511, it deviates after being incident to the first prism 351 due to refraction. To obtain a better use efficiency of the first light ray a, the angle θ has to be corrected according to the extent that the first light ray a deviates. As shown, when an angle α exists between the first and second light sources 31, 32, the first light ray a can be incident to the first prism 351 at the angle α by adjusting the first reflective mirror 33 in this embodiment. When an index of refraction n of the first prism 351 is known, a refracted angle β of the first light ray a can be obtained. With the refracted angle β obtained, the to-be-corrected amount of the angle θ can be found. Accordingly, the angle θ is a function of the refracted angle β, and the refracted angle β is a function of the angle α and the index of refraction n. Thus, the angle θ is directly dependent on the angle α and the index of refraction n. More specifically, the angle θ is formulated as the following equation:
θ=(90+sin−1((sin α)/n))/2. (1)
Analogously, the angles θ, α, β for the second prism 352 may also be deduced by equation (1).

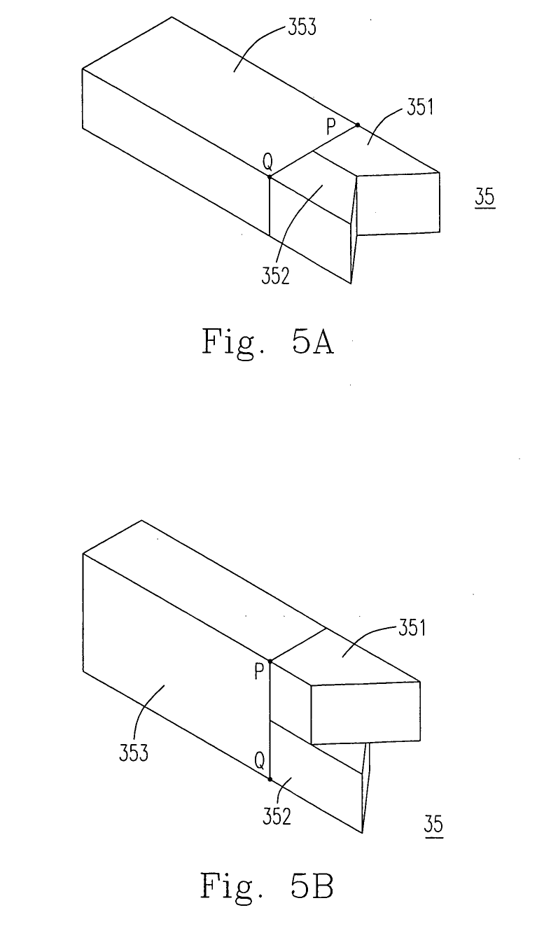

Referring to FIG. 5A and FIG. 5B, two possible arrangements of the light integrating device 35 are respectively shown therein. As mentioned above, the first and second light sources 31, 32 stand at an angle α with respect to each other and thus the first and second prisms 351, 352 stand side by side as shown in FIG. 5A. However, a long side of the exit surface of some light integrating rods stands at a vertical direction other than the horizontal direction. For example, an incident light is incident to a panel of the optical engine at forty-five degrees and an exit light exiting from the light integrating rod experiences two times of forth-five degree reflection in some DLP optical engines, causing the exit light to have ninety degrees of light path variation and then form an image on the panel. In this case, the first and second prisms 351, 352 may also be disposed in a stack configuration, as shown in FIG. 5B. In this embodiment, the other optical elements in the light source module only require an arrangement variation corresponding to the placement of the first and second prisms 351, 352 without the need of any new elements introduced. In addition, no matter which of the side-by-side configuration as shown in FIG. 5A or the stack configuration as shown in FIG. 5B is used, the respective exit surfaces of the first and second prisms 351, 352 are required to be closely connected to the incident surface of the light integrating rod 353 so that the light integrating device 35 may be prevented from causing a loss of the transmitted light and thus the light use efficiency may be enhanced. Namely, the incident surface of the light integrating rod 353 has an area identical to a total of areas of the first and second prisms.

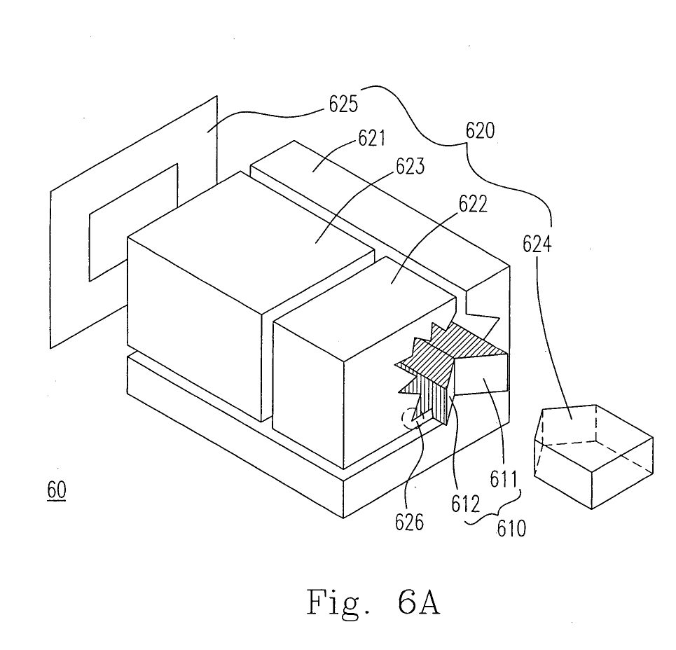

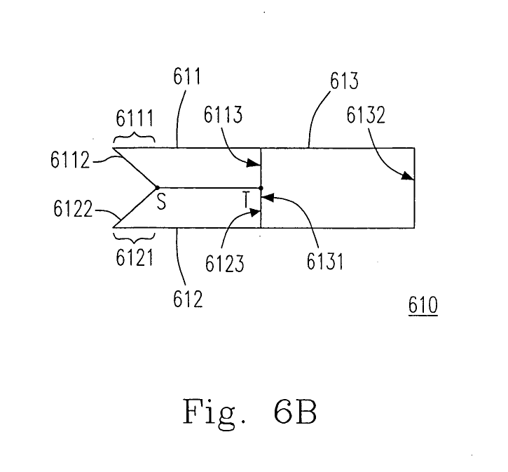

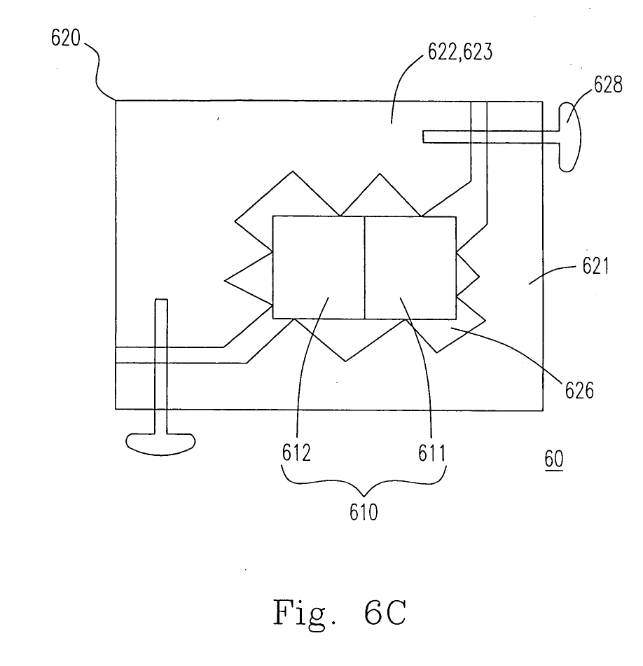

Referring to FIG. 6A through FIG. 6C, schematic diagrams of an assembly of the elements of the light integrating module according to another embodiment of the present invention are shown therein in different views. In FIG. 6A, a relationship of a light integrating mirror assembly 610 and a metal bracket 620 in the light integrating module 60 is shown therein. As shown, the light integrating mirror assembly 610 is borne on and fixed by the metal bracket 620 and a plurality of members 621-625. In FIG. 6B, the light integrating mirror assembly 610 is shown therein. As shown, the light integrating mirror assembly 610 in this embodiment comprises a first prism 611, a second prism 612 and a light integrating rod 613. The first prism 611 has a first incident surface 6111, a first reflective surface 6112 and a first exit surface 6113. The second prism 612 has a second incident surface 6121, a second reflective surface 6122 and a first exit surface 6123. The light integrating rod 613 has a third incident surface 6131 and a third exit surface 6132. As shown in FIG. 6B, the first and second prisms 611, 612 are disposed in parallel along their long axes (a line segment ST). The light integrating rod 613 is connected closely in rear of the first and second prisms 611, 612. To avoid the light from having a loss when transmitted by the light integrating mirror assembly 610, the first and second exit surfaces 6113, 6123 are connected directly to the third incident surface 6131. The plurality of members 621-625 of the metal bracket 620 are provided to calibrate the lenses 611-613 of the light integrating mirror assembly 610.

As shown in FIG. 6A, the metal bracket 620 comprises a base 621, a first side frame 622, a second side frame 623, a press cover 624 and a stop plate 625. Each of the first and second prisms 611, 612 has long side surfaces (shown as areas filled with oblique lines), which are fixed by the base 621 and the first side frame 622, respectively. The light integrating rod 613 also has long side surfaces, which are fixed by the base 621 and the second side frame 623, respectively. The first and second side frames 622, 623 are fixed to the base 21 through a screw 628 (shown in FIG. 6C). To closely connect the first and second exit surfaces 6113, 6123 to the third incident surface 6131, a front side surface and a rear side surface (the side surfaces contacted respectively with the press cover 624 and the stop plate 625) of the light integrating mirror assembly 610 are urged by the press cover 624 and the stop plate 625. As such, the elements 611, 612 of the light integrating mirror assembly 610 can be prevented from loosing from each other. In addition, since the light integrating mirror assembly 610 is provided for transmitting the light through a total reflection, the light integrating mirror assembly 610 should have a good reflectance. To achieve this, the base 621 and the first and second side frames 622, 623 are connected to the light integrating mirror assembly 610 through a slot structure 626. Accordingly, it may be seen from FIG. 6C that the light integrating mirror assembly 610 is only maintained in contact with the metal bracket 620 at a plurality of points on a cross-sectional surface of the metal bracket 620. Therefore, the reflectance of the light integrating mirror assembly 610 does not vary due to the contact with the metal bracket 620.

With utilization of the present invention, the light integrating device can be provided in cooperation with the light source arrangement and fixed in the light source module simply and rapidly without the need of additional complex elements.

While the invention has been described in terms of what is presently considered to be the most practical and preferred embodiments, it is to be understood that the invention needs not be limited to the disclosed embodiments. Therefore, it is intended to cover various modifications and similar arrangements included within the spirit and scope of the appended claims, which are to be accorded with the broadest interpretation so as to encompass all such modifications and similar structures.

What is claimed is:

1. A light source module, comprising:
a first and a second light sources generating a first and second light rays;
a first and a second reflective mirrors disposed on a respective light path of the first and second light rays to control a respective direction of the first and second light rays, respectively; and
a light integrating device having a first prism, a second prism and a light integrating rod and disposed behind the first and second reflective mirrors on the respective light paths of the first and second light rays,
wherein the first and second light rays are received by the first and second prisms respectively and collected to the light integrating rod.

2. The light source module as claimed in claim 1, wherein the first prism has a first exit surface, the second prism has a second exit surface and the light integrating rod has an incident surface connected with the first and second exit surfaces of the first and second prisms to collect and homogenize the first and second light rays.

3. The light source module as claimed in claim 1, wherein the light integrating device further comprises a metal bracket for fixing the first and second prisms and the light integrating rod.

4. The light source module as claimed in claim 3, wherein the metal bracket has a plurality of slots so that the first and second prisms and the light integrating rod are maintained in contact with the metal bracket at a plurality of points on a cross sectional surface of the metal bracket, respectively.

5. The light source module as claimed in claim 3, wherein the metal bracket further comprises a base, a first side frame, a second side frame, a press cover and a stop plate.

6. The light source module as claimed in claim 5, wherein each of the first and second prisms has at least a long side fixed between the base and the first side frame.

7. The light source module as claimed in claim 5, wherein the light integrating rod has at least a long side fixed between the base and the second side frame.

8. The light source module as claimed in claim 5, wherein each of the first and second prisms and the light integrating rod has a front side surface and a rear side surface respectively fixed by the press cover and the stop plate.

9. The light source module as claimed in claim 1, further comprising a first UV-filter and a second UV-filter disposed between the first and second light sources and between the first and second reflective mirrors, respectively.

10. The light source module as claimed in claim 1, wherein each of the first and second prisms has an incident surface and a reflective surface standing at an angle θ with respect thereto.

11. The light source module as claimed in claim 10, wherein the angle θ satisfies the following equation: θ=½[90°+sin⁻¹(sin(α)/n)], wherein α is an incident angle of one of the first and second light rays with respect to one of the first and second prisms, and n is an index of refraction of one of the first and second prisms.

12. The light source module as claimed in claim 1, wherein the light source module is used for a projector system.

13. A light integrating module for a projector system, comprising:
a first prism having a first exit surface and a long axis;
a second prism having a second exit surface, and disposed in parallel with the long axis of the first prism;
a light integrating rod having a third incident surface connected to the first and second light exit surfaces; and
a metal bracket bearing thereon and calibrating the first and second prisms and the light integrating rod.

14. The light integrating module as claimed in claim 13, wherein the metal bracket further comprises a base, a first side frame, a second side frame, a press cover and a stop plate.

15. The light integrating module as claimed in claim 14, wherein each of the first and second prisms has at least a long side fixed between the base and the first side frame.

16. The light integrating module as claimed in claim 14, wherein the light integrating rod has at least a long side fixed between the base and the second side frame.

17. The light integrating module as claimed in claim 14, wherein each of the first and second prisms and the light integrating rod has a front side surface and a rear side surface fixed by the press cover and the stop plate.

18. The light integrating module as claimed in claim 13, wherein the metal bracket has a plurality of slots so that the first and second prisms and the light integrating rod are maintained in contact with the metal bracket at a plurality of points on a cross sectional surface of the metal bracket, respectively.

19. The light integrating module as claimed in claim 13, wherein the light integrating device is used for a projector system.

20. A light source module, comprising:
a lamp tank having at least a pair of light sources and at least a pair of reflective mirrors for generating a first light ray and a second light ray;
a light integrating device having a pair of prisms and a light integrating rod for transmitting and homogenizing the first and second light rays; and
a metal bracket bearing thereon and calibrating the pair of prisms and the light integrating rod so as to reduce a loss of the first and second light rays transmitted and homogenized by the pair of prisms and the light integrating rod,
wherein each of the pair of prisms has a respective light exit surface and the light integrating rod has an incident surface connected therewith so that the first and second light rays are transmitted to the light integrating rod and collected, homogenized by the light integrating rod.

21. The light source module as claimed in claim 20, wherein the incident surface of the light integrating rod is connected totally with the respective light exit surface of each of the pair of prisms.

22. The light source module as claimed in claim 21, wherein each of the first and second light rays is incident into the pair of prisms after one time of reflection.

23. The light source module as claimed in claim 21, wherein the pair of reflective mirrors are respectively used to adjust positions of the first and second light rays incident onto the pair of prisms.

24. The light source module as claimed in claim 21, further comprises a pair of UV-filters between the pair of light sources and the pair of reflective mirrors.

25. The light source module as claimed in claim 21, wherein the metal bracket has a plurality of slots so that the pair of prisms and the light integrating rod are maintained in contact with the metal bracket at a plurality of points on a cross sectional surface of the metal bracket, respectively.

26. The light source module as claimed in claim 21, wherein the metal bracket further comprises a base, a first side frame, a second side frame, a press cover and a stop plate.

27. The light source module as claimed in claim 26, wherein each of the first and second prisms has at least a long side fixed between the base and the first side frame.

28. The light source module as claimed in claim 26, wherein the light integrating rod has at least a long side fixed between the base and the second side frame.

29. The light source module as claimed in claim 26, wherein each of the pair of prisms and the light integrating rod has a front side surface and a rear side surface respectively fixed by the press cover and the stop plate.
